(19) United States
(12) Patent Application Publication
(10) Pub. No.: US 2024/0411669 A1
(43) Pub. Date: Dec. 12, 2024

(54) FUNCTIONAL TESTING OF USER INTERFACE BASED APPLICATIONS USING HEAT MAPS

(71) Applicant: Dell Products L.P., Round Rock, TX (US)

(72) Inventors: Lavanya Rameshkumar, Singapore (SG); Richa Sahu, Singapore (SG); Deepanwita Roy, Singapore (SG); Madhusmita Sahu, Singapore (SG)

(21) Appl. No.: 18/329,813

(22) Filed: Jun. 6, 2023

(51) Int. Cl. G06F 11/36; G06F 9/451; G06T 11/00

(52) U.S. Cl. CPC G06F 11/3664; G06F 9/451; G06F 11/3692; G06T 11/00; G06T 2200/24

(57) ABSTRACT

Techniques are described for performing functional testing of user interface (UI)-based applications using heat maps. According to an embodiment, a system is provided that comprises a memory that stores computer-executable components, and a processor that executes the computer-executable components stored in the memory. The computer-executable components comprise a heatmap component that employs a heatmap generation tool to track interface elements of a UI-based application executed by an automated UI test program, and a reporting component that generates report data regarding the interface elements that were executed. In some implementations, the heatmap component employs the heatmap generation tool to generate heatmap data for the interface elements that were executed, and wherein the report data comprises the heatmap data.

### BACKGROUND

Functional testing is used in the software delivery lifecycle to ensure that an application is working correctly and providing the expected results. Software developers use functional testing as a method to perform quality assurance and determine whether the product works as expected. To do this effectively, functional testing also verifies all requirements are met, all security is up to standard, all defects are removed, and the quality of the product meets needs.

Examining if an application works as initially designed takes tremendous time and resources if done manually. Accordingly, many automated functional testing tools have been developed to automate the functional testing process, such as Selenium™, Cypress™ and various others. However, current automated functional testing tools are not devoid of challenges. Automated testing tools and frameworks typically focus on evaluating an application's code and functionality, rather than testing what the user sees and experiences. As a result, they may miss more bugs than human testers who can directly observe and interact with the user interface. A certain functionality might not be tested, leading to defect leakage in production and consequently customer dissatisfaction. In addition, automated tools typically require proficiency in programming which leaves room for human error. Accordingly, the existing process to identify gaps in automated functional testing is through manual review. This method of review is often inaccurate and inefficient.

### SUMMARY

The following presents a summary to provide a basic understanding of one or more embodiments of the present application. This summary is not intended to identify key or critical elements or delineate any scope of the different embodiments or any scope of the claims. Its sole purpose is to present concepts in a simplified form as a prelude to the more detailed description that is presented later. In one or more embodiments, systems, computer-implemented methods, apparatus and/or computer program products are described for functional testing of UI-based applications using heat map, and more specifically for maximizing user-based application testing efficiency with heat map functional coverage analysis.

According to an embodiment, a system is provided that comprises a memory that stores computer-executable components, and a processor that executes the computer-executable components stored in the memory. The computer-executable components comprise a heatmap component that employs a heatmap generation tool to track interface elements of a UI-based application executed by an automated UI test program, and a reporting component that generates report data regarding the interface elements that were executed. In some implementations, the heatmap component employs the heatmap generation tool to generate heatmap data for the interface elements that were executed, and wherein the report data comprises the heatmap data. In some implementations, the heatmap data comprises graphical heatmap elements for the interface elements that were executed, and the computer executable components further comprise a rendering component displays the graphical heatmap elements at positions relative to the interface elements as rendered via a display device. In some implementations, the computer-executable components further comprise an assessment component that determines test coverage information regarding non-executed interface elements of the UI-based application that were not executed by the automated UI test program, and wherein the reporting component includes the test coverage information in the report data.

In some embodiments, elements described in connection with the disclosed systems can be embodied in different forms such as a computer-implemented method, a computer program product, or another form.

### DESCRIPTION OF THE DRAWINGS

FIG. 1 illustrates an example, non-limiting system that facilitates functional testing of UI-based applications using heat maps in accordance with one or more embodiments of the disclosed subject matter.

FIG. 2 presents a flow diagram of an example high-level process for performing functional testing of UI-based applications using heat maps in accordance with one or more embodiments of the disclosed subject matter.

FIG. 3 presents a flow diagram of another example process for performing functional testing of UI-based applications using heat maps in accordance with one or more embodiments of the disclosed subject matter.

FIG. 4 presents an example graphical user interface (GUI) of a test coverage reporting tool for assessing the functionality of UI-based applications using heat maps in accordance with one or more embodiments of the disclosed subject matter.

FIG. 5 presents another example GUI of a test coverage reporting tool for assessing the functionality of UI-based applications using heat maps in accordance with one or more embodiments of the disclosed subject matter.

FIG. 6 presents another example GUI of a test coverage reporting tool for assessing the functionality of UI-based applications using heat maps in accordance with one or more embodiments of the disclosed subject matter.

FIG. 7 presents another example GUI of a test coverage reporting tool for assessing the functionality of UI-based applications using heat maps in accordance with one or more embodiments of the disclosed subject matter.

FIG. 8 illustrates a block diagram of an example, non-limiting computer implemented method performing functional testing of a UI-based application using heat maps in accordance with one or more embodiments of the disclosed subject matter.

FIG. 9 illustrates a block diagram of an example, non-limiting operating environment in which one or more embodiments described herein can be facilitated.

FIG. 10 illustrates a block diagram of another example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background section, Summary section or in the Detailed Description section.

As mentioned in the Background section, conventional automated tools and frameworks are inadequate and manual review is often inaccurate and inefficient. Hence, there is a need for functional test coverage tools that overcome these deficiencies.

The disclosed subject matter is directed to systems, computer-implemented methods, apparatus and/or computer program products that facilitate functional testing of UI-based applications using heat maps. More specifically, the disclosed subject matter provides techniques that maximize user-based application testing efficiency with heat map functional coverage analysis. The disclosed techniques can be applied to any GUI-based application to test the functionality of its interactive GUI elements, including web applications, mobile applications, native applications, hybrid applications, desktop applications and others. The terms UI and GUI are used herein interchangeably unless otherwise specified.

In this regard, various automated functional testing tools have been previously developed that facilitate testing functionality of software applications elements, such as, but not limited to, Selenium™, Cypress™ and many others. The disclosed techniques leverage these existing automated functional testing tools in combination with one or more existing heatmap generation tools (e.g., Google Analytics™, Microsoft Clarity™, and similar heatmap generation tools) to generate detailed test coverage reports for UI based applications. In one or more embodiments, the disclosed techniques run one or more UI automation tests on UI-based application selected for testing and generate the corresponding automated test results. The one or more UI automation tests can include any available UI automation testing tool that simulates user actions or behaviors with respect to interacting with the UI elements of the application being tested (e.g., clicking, scrolling, entering inputs, etc.). At the same time as the UI automation test is being executed, the disclosed techniques run a heatmap generation tool that tracks the simulated user actions and the UI elements that are executed by the UI automation testing tool. The heatmap generation tool utilized can include any existing or future developed heatmap generation tool (e.g., Google Analytics™, Microsoft Clarity™, and similar heatmap generation tools). The heatmap generation tool generates information regarding the UI elements that were executed by the UI automation test, including elements that were clicked, number of clicks, timing of clicks, order of clicks, and so on. The heatmap generation tool further generates a heatmap that provides a visual representation of the UI elements that were executed by the UI automation testing tool, the order in which they were executed and the frequency in which they were executed (e.g., number of clicks).

The disclosed techniques further generate a detailed test coverage report that can be presented to a user that facilitates efficient review of the UI automation test results. The detailed test coverage report can include the heatmap as displayed with the GUI of the application that was tested. The heatmap can include visual heatmap elements displayed as overlay data and/or embedded within the application at positions corresponding to the graphical elements that were executed by the automated test tool. The visual heatmap elements can provide visual indicators that reflect the number of clicks of the respective executed UI elements as well as the order in which they were executed by the automated test tool.

As noted in the Background Section, the results of existing UI automation testing tools generally require detailed manual review to assess what UI elements were not executed by the automated tool. In one or more embodiments, the disclosed techniques further improve this review process by providing an automated and comprehensive assessment of the UI elements that were not executed by the UI automation test tool. To facilitate this end, the disclosed techniques employ one or more existing web-scraping tools to identify or extract all testable UI elements of the application being tested. The one or more web-scraping tools can be executed at the same time of execution of the UI automation tool and the heatmap generation tool to identify and extract all testable UI elements. In some embodiments, the disclosed techniques can retrigger web scraping every time a dynamic element is loaded during execution of the UI automation tool so that all web elements will be captured. As used herein, a dynamic element refers to any UI element that is conditionally rendered in response to a trigger event, such as a user action or behavior in association with interacting with the UI-based application (e.g., an element that is rendered in response to scrolling, clicking, etc.). With these embodiments, the detailed test coverage report can further include comprehensive information regarding all of the UI elements that were not executed by the UI automation test tool.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

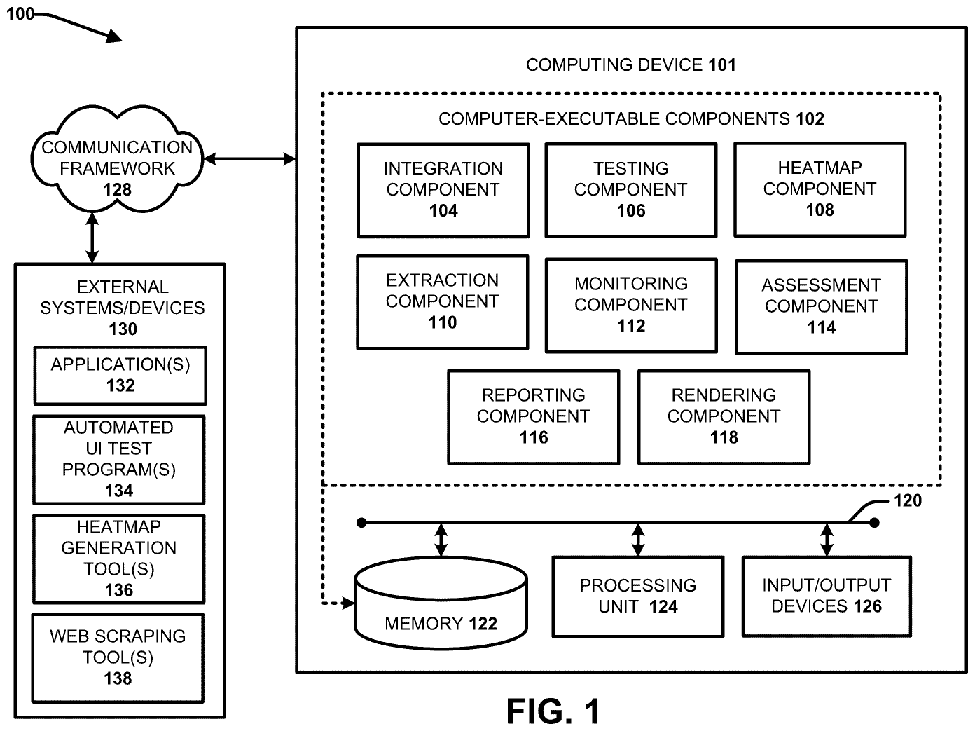

Turning now to the drawings, FIG. 1 illustrates a block diagram of an example, non-limiting system 100 system that facilitates functional testing of UI-based applications using heat maps in accordance with one or more embodiments of the disclosed subject matter. Embodiments of systems described herein can include one or more machine-executable components embodied within one or more machines (e.g., embodied in one or more computer-readable storage media associated with one or more machines). Such components, when executed by one or more machines (e.g., processors, computers, computing devices, virtual machines, etc.) can cause the one or more machines to perform the operations described.

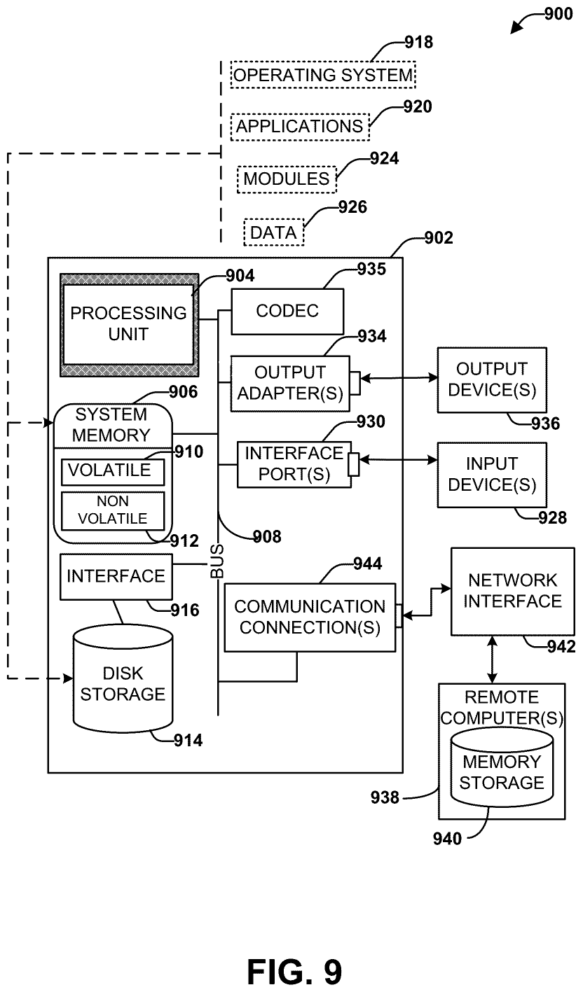

For example, system 100 includes a computing device 101 that includes several computer-executable components 102, including integration component 104, testing component 106, heatmap component 108, extraction component 110, monitoring component 112, assessment component 114, reporting component 116 and rendering component 118. These computer/machine executable components can be stored in memory associated with the one or more machines. The memory can further be operatively coupled to at least one processing unit such that the components can be executed by the at least one processing unit to perform the operations described. For example, in some embodiments, these computer/machine executable components can be stored in memory 122 of the computing device 101 which can be coupled to processing unit 124 for execution thereof. Examples of said and memory 122 and processing unit 124 as well as other suitable computer or computing-based elements, can be found with reference to FIG. 9, and can be used in connection with implementing one or more of the systems or components shown and described in connection with FIG. 1 or other figures disclosed herein.

The computing device 101 can further include one or more input/output devices 126 to facilitate receiving user input in association with performing functional testing of UI-based applications and/or rendering information to users in association reporting the results of the functional testing. In this regard, any information received by and/or generated by the computing device 101 can be presented or rendered to a user via any suitable output device, such as a display device, a speaker or the like, depending on the data format. In various embodiments, the rendering component 118 can generate an interactive visual representation (e.g., a GUI) that includes the results of the functional testing tools disclosed herein. With these embodiments, the input/output devices 126 can include a display device capable of rendering the results GUI and one or more suitable input devices (e.g., a keyboard, a touchscreen, etc.) that provide for receiving user input in association with interacting with the results GUI. Suitable examples of the input/output devices 126 are described with reference to FIG. 9 (e.g., input devices 928 and output device 936). The computing device 101 can further include a device bus 120 that couples the memory 122, the processing unit 124 and the input/output devices 124 to one another.

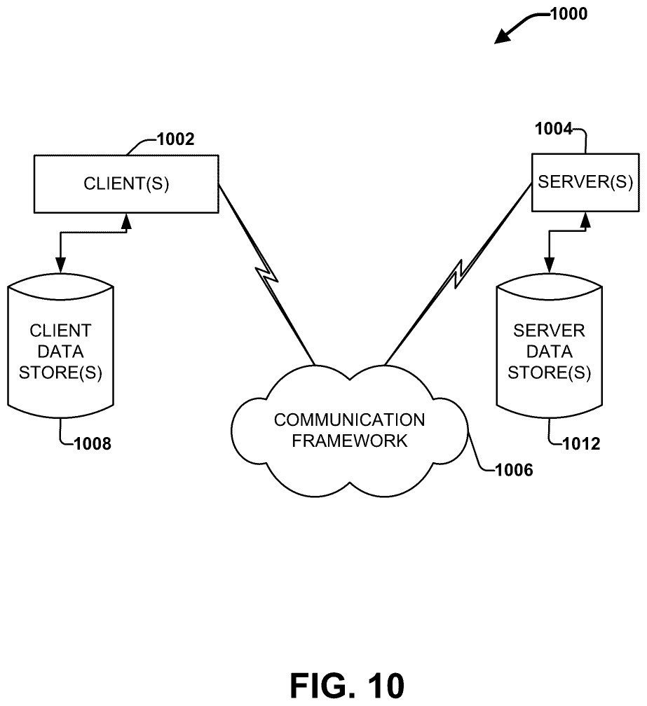

System 100 can further include one or more external devices/systems 130 and a communication framework 128 that communicatively couples the computing device 101 to the one or more external devices/systems 130. The communication framework 128 can include any suitable wired or wireless communication networks (e.g., the Internet and the like). The computing device 101 and the external systems/devices 130 can include suitable communication hardware and software that enables communication between the respective devices and systems via the communication framework 128, example of which are described with reference to FIGS. 9 and 10. In this regard, the external systems/devices 130 can correspond to one or more network accessible computing systems and/or devices that provide (e.g., store in suitable memory and/or otherwise provide access to) one or more UI-based applications (applications 132) to be tested using the functional testing techniques disclosed herein. The applications 132 can include web-applications, mobile applications, native applications, hybrid applications, desktop applications and any other type of software application having interactive UI elements. The one or more external systems/devices 130 can also include or correspond to one or more network accessible computing devices/systems that provide (e.g., store in suitable memory and/or otherwise provide access to) one or more automated UI test programs, one or more heatmap generation tools 136, and/or one or more web scraping tools 138.

The terms “program,” “tool,” “application,” “platform,” and the like are used herein interchangeably (unless context warrants particular distinction amongst the terms) to refer to computer-executable components or instructions (e.g., coded instructions written in a computer program language) embodied within one or more machines (e.g., embodied in one or more computer-readable storage media associated with one or more machines). Such components, when executed by the one or more machines (e.g., processors, computers, computing devices, virtual machines, etc.) can cause the one or more machines to perform the operations described. In this regard, it should be appreciated that the external systems/devices 130 can correspond to machines (e.g., computer, computing devices, virtual machines, etc.) comprising one or more of the applications 132, the automated UI test programs 134, the heatmap generation tools 136, and/or the web scraping tools 138 embodied in one or more computer-readable storage media associated with the machines. In some embodiments, the machines can further include or be associated with one or more processors or processing units that can execute the respective applications, programs and/or tools. In other embodiments, one or more of the applications 132, the automated UI test programs, the heatmap generation tools 136 and/or the web scraping tool 138 may be stored in memory 122 of the computing device 101 and/or deployed/executed locally by the computing device 101. In this regard, the architecture of system 100 can vary.

The automated UI test programs 134 can include one or more existing or later developed UI automation test tools (e.g., computer executable programs, applications, platforms, frameworks, etc.) that simulate user actions or behaviors (e.g., clicking, scrolling, entering inputs, etc.) with respect to interacting with the UI elements of UI-based application in association with performing an automated UI-functionality test on the application. In this regard, functional testing is a type of software testing that validates the software system against the functional requirements/specifications. The purpose of functional tests is to test each function of the software application, by providing appropriate input and verifying the output against the functional requirements. Functional testing can be used to test UI-element functionality, application program interface (API), database functionality, security functionality, client/server communication and other functionality of the application under test. The disclosed techniques are concerned with functional testing of UI-elements of an application that have or are intended to have a defined functionality. Automated test programs that test UI-element functionality use one or more defined functional test cases that are computer-executable scripts configured to test the functionality of one or more defined UI-elements of a UI-based application. A functional UI test case can be attached to one or more certain UI element functions or features of the application and verifies if it produces the expected result as mentioned in the business specification or functional specification document associated with the application. In various embodiments, the automated UI test programs 134 can include or correspond to a plurality of different functional UI test cases configured to test the functionality of different types of UI-elements. Each test case typically defines a set of test inputs, execution conditions, and expected results developed for a particular objective, such as to exercise a particular program path or to verify compliance with a specific requirement. For example, the one or more automated UI test programs 134 may include a first test case configured to test the functionality of an application's login page functionality, a second test case adapted to test the home page selectable menu buttons, a third test case configured to test the functionality of review posting form, and so on.

In some embodiments, the one or more automated UI test programs 134 may be open-source testing tools that include various test cases that can be applied to any UI based application. In other embodiments, the one or more automated UI test programs 134 can include one or more test cases that have been specifically developed for a particular UI-based application of interest. In some embodiments, the one or more automated UI test programs 134 may provide a suite of automated UI-tests that can be applied to a UI-based application, wherein the suite includes a plurality of different automated UI test cases. Some examples of some suitable automated UI test programs include but are not limited to, Selenium™, Cypress™, Appium™, Scriptworks™, SoapUI™, HP Unified Functional Testing™, Ranorex™, TestComplete™, and Tricentis Tosca™, and many others.

The one or more heatmap generation tools 136 can include any existing or future developed heatmap generation tool that generates heatmap information regarding tracked user actions and behaviors in association with interacting with UI elements of a UI-based application. A heatmap is a two-dimensional representation of data in which values are represented by colors. A heat map uses a warm to cold color spectrum in which the warm areas' values are high and the cold areas' values are low. Heatmaps have a wide range of possibilities amongst applications due to their ability to simplify data and make for visually appealing to read data analysis. There are many different ways heatmaps are used within web applications and mobile applications to determine a visiting user's actions. Typically, there are multiple heatmaps used together to determine insight to a website on what are the best and worst performing elements on the page. For example, some specific heatmap generation tools used for UI-based application analytics include mouse tracking heatmap generation tools, eye tracking heatmap generation tools, click-tracking heatmap generation tools and scroll-tracking heat map generation tools. Mouse tracking heatmapping tools (also referred to as hover tracking heatmapping tools), are used to track and visualize where the user of the site hovers their cursor. Eye-tracking heatmap tools track and measure the eye position of the website's users and gather measurements, such as eye fixation volume, eye fixation duration, and areas of interest. Click tracking (also referred to as touch tracking) heatmap tools are similar to mouse tracking heat maps, but instead of hover actions, these types of heatmapping tools track and the user's click actions and generate visual visual cues on clickable components on GUI, such as buttons or dropdown menus, etc. Scroll tracking heat mapping tools are used to track and visualize the scrolling behavior of the website's users. This helps produce visual cues to what section on the website the user spends the most time viewing.

The disclosed techniques leverage one or more existing (or future developed) heatmap generation tools developed for tracking user behaviors and interactions with web applications (e.g., websites) and/or mobile applications and apply them to track the simulated user behaviors and interactions with a UI-based application as simulated by one or more automated UI test programs 134. More specifically, the disclosed techniques are concerned testing which UI elements of the UI-based application are functioning as expected and thus successfully executed by the automated UI-test programs 134. Accordingly, applicable heatmap generation tools can include any heatmap generation tool which tracks user interaction with executable UI elements, including any available click tracking heatmap generation tools that track user click actions and generates visual cues on clickable (or executable) UI components of GUI, such as buttons, dropdown menus, data entry forms, and so on. In some embodiments, the heatmap generation tools can also include mouse-tracking heatmap generation tools and/or scroll tracking heatmap generation tools. With these embodiments, the mouse-tracking heatmap generation tools may be used to track and visualize mouse and scrolling actions simulated by one or more automated UI-test programs in association with testing the functionality of a UI-based application. In some implementations of these embodiments, some applications may have one or more UI-elements that are configured to be executed in response to defined mouse and/or scrolling actions. For example, a UI-element may be configured to execute some functionality (e.g., change appearance, initiate playing, initiate a sound, etc.) in response to hovering over the element, moving a mouse cursor over or near the element, scrolling and bring the element into view, and so on. Some examples of existing heatmap generation tools that may be included in the heatmap generation tools 136 include but are not limited to, Google Analytics™ and Microsoft Clarity™.

The one or more web scraping tools 138 can include any existing or future developed web-scraping tool (e.g., computer-executable software application, program, platform, etc.) that can identify and extract information in a structured format regarding testable UI elements of a UI-based application that are executable or intended to be executable to generate an output (e.g., clickable, selectable, etc.). In this regard, reference to a “testable” UI-element refers to any UI element that is executable or intended to be executable to produce a defined output in response to a user action-based trigger event (e.g., clicking, selection, hovering, scrolling, etc.). For example, the one or more web scraping tools 138 can include automated web scraping tools that use Python scripts or Scrapy libraries to extract content from webpages and mobile application pages. These automated web-scraping tools typically work by sending hypertext transfer protocol (HTTP) requests to the servers hosting the targeted web-application or mobile application content. The servers return the HTML source code for the targeted pages. The scraping tool parses the HTML and extracts the desired data in a structured format, which in this context includes the executable UI-elements of the application. The extracted data can be saved for further analysis or processing.

In some embodiments, the integration component 104 can provide for accessing one or more of the applications 132 for performing functional UI-testing thereon as deployed at one or more external systems/devices 130. In some implementations, the integration component 104 can load a copy of the application to be tested into local memory of the computing device 101 (e.g., memory 122). The integration component 104 can also provide for accessing and applying one or more of the automated UI test programs 134, one or more of the heatmap generation tools 136 and/or one or more of the web-scraping tools 138 to the application under test via the communication framework as software-as-a-service (SAAS). In this regard, the integration component 104 can integrate the application under test with one or more of the automated UI test programs 134, one or more of the heatmap generation tools 136 and/or one or more of the web-scraping tools 138 using defined APIs for the respective applications, programs, and/or tools. In other embodiments, the one or more of the automated UI test programs 134, the one or more of the heatmap generation tools 136 and/or one or more of the web-scraping tools 138 may be deployed locally by the computing device 101 (e.g., stored in memory 122 and executed by the processing unit 124).

In various embodiments, the testing component 106 can execute (e.g., using processing unit 124) or control execution (e.g., by one or more external system/devices 130) of one or more automated UI test programs 134 on a UI-based application (of the applications 132) selected for functional UI testing. The heatmap component 108 can execute (e.g., using processing unit 124) or control execution (e.g., by one or more external system/devices 130) of one or more heatmap generation tools 136 in association with execution of the one or more automated UI test programs 134 by the testing component 106. For example, the heatmap component 108 can execute or control execution of the one or more heatmap generation tools 136 at the same time of execution of the one or more automated UI test programs 134 on the application under test. In this regard, the heatmap component 108 can employ one or more heatmap generation tools 136 track interface elements of the application that are executed (e.g., successfully executed to generate their defined output) by the one or more automated UI test programs 136. In some implementations, the heatmap component 108, using the one or more heatmap generation tools 136, the heatmap component 108 can also track information regarding the order of execution of the UI-elements, the timing of execution, the amount of execution (e.g., number of clicks) and/or the frequency of execution. In addition, the heatmap component 108 can employ the one or more heatmap generation tools 138 to generate heatmap data for the interface elements that were executed. For example, the heatmap data can comprise graphical heatmap elements or icons that provide a visual representation of the amount and/or frequency of execution of each UI element that was successfully executed by the one or more automated UI test programs 134.

In some embodiments, the extraction component 110 can also execute (e.g., using processing unit 124) or control execution (e.g., by one or more external system/devices 130) of one or more web scraping tools 138 on the application under test to extract information regarding the testable UI elements encoded for the application. In this regard, using one or more web scaping tools 138, the extraction component 110 can determine the total amount of testable UI elements encoded for the application. As noted above, the testable UI elements can include any UI element having a testable functionality. In some embodiments, using one or more web scaping tools 138, the extraction component 110 can extract testable UI element information that uniquely identifies all testable UI elements of the application under test in a structured format. For example, the extraction component 110 can extract all testable UI elements as web elements (e.g., HTML elements) defined by a start tag, an end tag and content data defined between the start tag and the end tag (e.g., <start tag> content </end tag>). In some implementations, the extraction component 110 can also extract and/or generate path information and location information for each testable UI element using the one or more web scraping tools 138. For example, the path information may include or correspond to the XPath for the testable UI element. The extensible markup language (XML) Path Language (XPath) is a structured expression used to uniquely identify or address parts of an XML document, which in this case corresponds to a testable UI element of the application under test's XML document structure. An XPath expression can be used to search through an XML and hypertext markup language (HTML) document, and extract information from any part of the document, such as an element or attribute (referred to as a node in XML) in it. For example, the Xpath for a login form (e.g., a testable UI element) of an application may be written as follows: //form [@id=‘loginForm’]/input [3]. In some implementations, the testable UI element location information may include or correspond to a cascading style sheets (CSS) locator for the element. CSS is a style sheet language used for describing presentation of a document written in a markup language such as HTML or XML. CSS locators identify an element based on an attribute and its value. CSS locators mainly use the character sequence pattern, which identifies the web elements based on their HTML structure. CSS locator is one of the locator strategies offered by Selenium™ to identify the web elements. For example, a CSS locator for an input box may be written as follows: input [id=‘firstName’].

In some embodiments, the extraction component 110 can execute or (e.g., using processing unit 124) or control execution (e.g., by one or more external system/devices 130) of one or more web scraping tools 138 on the application under test to extract information regarding the testable UI elements encoded for the application at any time before or after initiation of execution of the one or more automated UI test programs 134 by the testing component 106. In other embodiments, the extraction component 110 can execute (e.g., using processing unit 124) or control execution (e.g., by one or more external system/devices 130) of one or more web scraping tools 138 on the application to extract information regarding the testable UI elements encoded for the application in association with the execution of the one or more automated UI test programs 134 the testing component 106. For example, the extraction component 110 can employ the one or more web scraping tools to extract information identifying all testable UI elements of the application at the same time of performance of the automated UI tests (e.g., while the tests are running).

In some implementations of these embodiments, the monitoring component 112 can facilitate identifying and extracting dynamic UI elements of the application under test by the extraction component 110. As used herein, a dynamic element refers to any UI element that is conditionally rendered in response to a trigger event, such as a user action or behavior in association with interacting with the UI-based application (e.g., an element that is rendered in response to scrolling, clicking, etc.). Another example of a trigger event can include the successful execution of a UI element. For instance, selection of a one UI element may result in rendering of a new dynamic UI element. In various embodiments, the trigger events can include or correspond to document object model (DOM) events. DOM events are a signal that something has occurred, or is occurring, and can be triggered by user interactions or by the browser. Examples of DOM events include but are not limited to: when a user clicks the mouse, when a web page has loaded, when an image has been loaded, when the mouse moves over an element, when an input field is changed, when an HTML form is submitted, and when a user presses a key.

With these embodiments, the monitoring component 112 can monitor the execution of the automated UI test program on the application under test and detect loading of dynamic interface elements. The monitoring component 112 can further prompt or trigger the extraction component to extract information regarding the testable UI elements of the application in response to detection of the loading of the dynamic interface elements. For example, each time the monitoring component 112 detects loading of a new UI element (e.g., a dynamic UI element), the monitoring component 112 can trigger the extraction component 110 to perform web scraping on rendered application content using the one or more web scraping tools 138. In some embodiments, to facilitate this end, the monitoring component 112 can employ a mutation observer tool to detect loading of dynamic UI elements and retrigger web-scraping. A mutation observer is a built-in object (e.g., a web API) that observes a DOM element and fires a callback when it detects a change. On example of a suitable mutation observer that can be employed by the monitoring component 112 to detect loading of dynamic UI elements includes the JavaScript Mutation Observer™.

In some embodiments, the assessment component 114 can further determine test coverage information regarding non-executed interface elements of the tested application that were not executed by the one or more automated UI test programs 134 based on the identified executed elements (e.g., as determined by the heatmap component 108) that were successfully executed by the one or more test cases and all of the testable UI elements extracted by the extraction component 110. In particular, the assessment component 114 can determine an amount of the non-executed interface elements as a function of the total amount of testable interface elements (e.g., obtained via web-scraping) relative to the interface elements that were executed (e.g., obtained via the heatmap generation tools). For example, in some implementations, the assessment component 114 can generate a test coverage percentage metric that represents the percentage of UI elements tested by the one or more automated UI test programs using the following Equation:

$$Coverage \% = ( \frac{Number of Elements Executed}{Total Number of Testable Elements} ) \times 100$$

The assessment component 114 can also determine result information identifying each of the non-executed interface elements by subtracting the known executed elements from the known testable elements. For example, the information identifying the non-executed interface elements may include unique identifiers for each of the non-executed elements, Xpath information, CSS information, or the like.

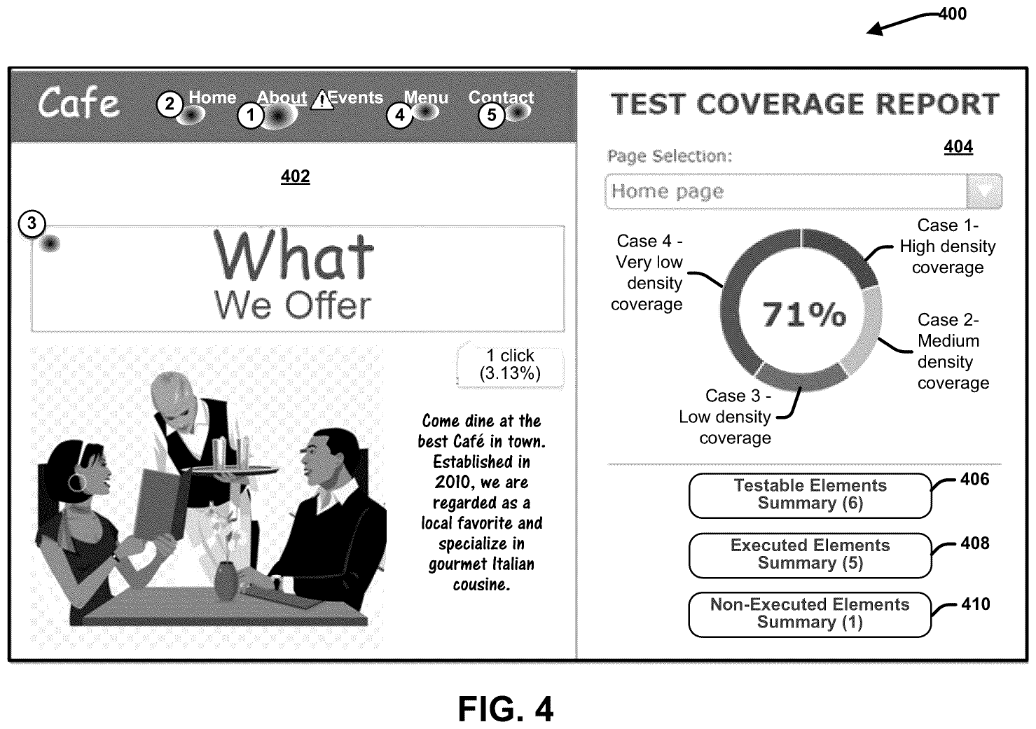

The reporting component 116 can further generate report data regarding the results of the one or more automated UI test programs 134, the one or more heatmap generation tools 136, the one or more web scraping tools 138 and/or the assessment component 114. For example, the report data can include but is not limited to: information identifying all executed UI elements by the one or more automated UI test programs (e.g., as determined by the heatmap component 108 using the one or more heatmap generation tools 136), information identifying all non-executed elements (e.g., as determined by the assessment component 114), the test coverage percentage metric, information identifying the amount, timing, order and/or frequency of execution of the executed UI elements (e.g., as determined by the heatmap component 108), the number of executed UI elements, the number of non-executed UI elements, and information identifying all of the testable UI elements (e.g., as determined by the extraction component 110). In some embodiments, the report data can include the XPath and/or CSS information for all testable UI elements, the executed UI elements and the non-executed UI elements. With these embodiments, a user can easily select (e.g., copy and paste or follow) the XPath and/or CSS information to navigate through the application's HTML structure to review and investigate potential coding issues with the non-executed UI elements. In this regard, the report data generated by the reporting component 116 can be stored (e.g., in memory 122 or another suitable memory structure), exported (e.g., transmitted) and/or rendered to user (e.g., via rendering component 118) via a suitable output device (e.g., of input/output devices 126). In some embodiments, the reporting component 116 can generate and/or provide the report data in the form of an interactive report GUI that facilitates efficient review of the report data and the rendering component 118 can render the report GUI to a user via suitable device display (e.g., as illustrated in FIGS. 4-7).

In some embodiments, the report data can also include the heatmap data generated by the heatmap component 108 using the one or more heatmap generation tools 136. As noted above, the heatmap data can comprise graphical heatmap elements for the interface elements that were executed. For example, the graphical heatmap elements can include visual indicators that indicate the amount, timing, order and/or frequency of execution of the executed UI elements. In some implementations of these embodiments, in association with rendering the report data, the rendering component 118 can display the graphical heatmap elements at positions relative to the corresponding executed interface elements of the tested UI application as rendered via a display device (e.g., as illustrated in FIG. 4). For example, in some embodiments, the reporting component 116 and/or the heatmap component 108 can embed the graphical heatmap elements within the UI-based application at positions relative to the interface elements. In other implementations, the reporting component 116 and/or the heatmap component 108 can overlay the graphical heatmap elements as overlay data at positions relative to the interface elements as rendered via the display device.

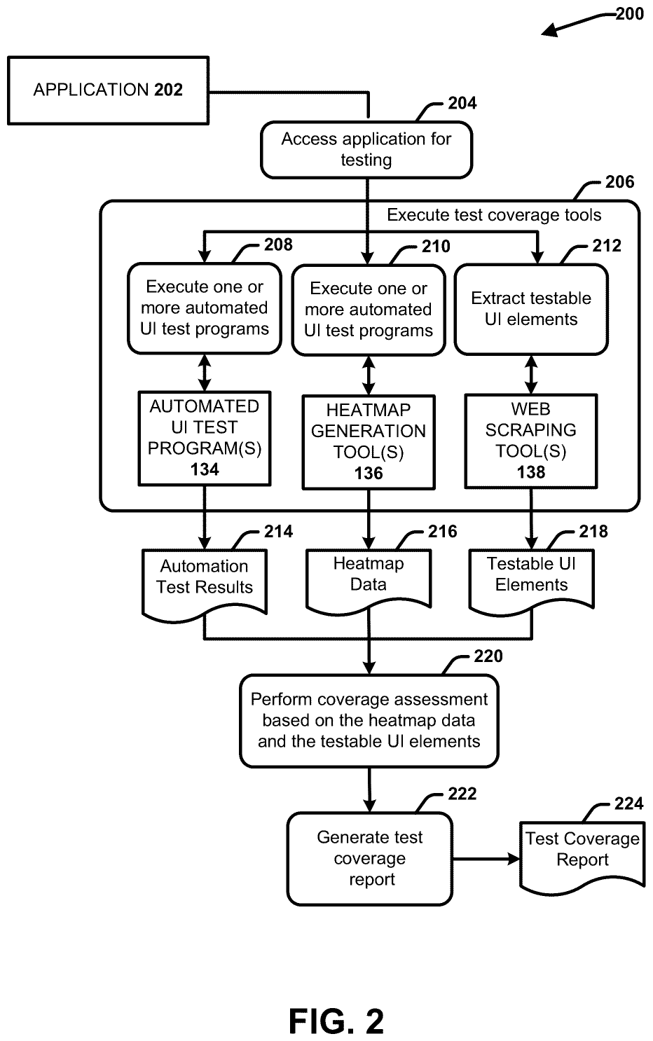

FIG. 2 presents a flow diagram of an example high-level process 200 for performing functional testing of UI-based applications using heat maps in accordance with one or more embodiments of the disclosed subject matter. With reference to FIGS. 1 and 2, process 200 corresponds to an example process that can be performed by system 100 to perform functional testing of executable UI elements of a UI-based application and generate a corresponding comprehensive test coverage report. Repetitive description of like elements employed in respective embodiments is omitted for sake of brevity.

In accordance with process 200, at 204 the computing device 101 can access an application 202 for testing (e.g., using integration component 104). For example, application 202 can correspond to an application of the one or more applications 132 (e.g., a web application, a mobile application, etc.). At 206, the computing device 101 can execute (e.g., using processing unit 124) and/or control execution (e.g., by one or more external systems/devices 130) of one or more automated UI test coverage tools on the application 202 (e.g., using testing component 106, heatmap component, extraction component 110, monitoring component 112 and/or integration component 104). The test coverage tools can include one or more automated UI test programs 134, one or more heatmap generation tools 136 and one or more web scraping tools 138. In various embodiments, at 206, the computing device can execute and/or control execution of the automated UI test programs 134, the heatmap generation tools 136, and the web scraping tools 136 on the application 202 simultaneously.

In this regard, at 208, the integration component 104 can integrate the application 202 with one or more automated UI test programs 134 and the testing component 106 can execute or control execution of the one more automated UI test programs 134 on the application 202. As described above the one or more automated UI test programs can perform one or more UI-element functional test cases on the application 202 that involve simulating user interaction with one or more testable UI elements encoded for the application 202 (e.g., simulating clicking buttons, mouse movement, scrolling, data entry, etc.). At 210, the integration component 104 can integrate the application 202 with one or more heatmap generation tools 136 and the heatmap component 108 can execute or control execution of the one or more heatmap generation tools 136 on the application 202 while the one or more automated test programs 134 are being executed on the application 202 to track and generate heatmap data regarding the executed UI elements that are successfully executed by the one or more automated UI test programs 134 based on the simulated user interactions. At 212, the integration component 104 can integrate the application 202 with one or more web scraping tools 138 and the extraction component 110 can execute or control execution of the one or web scraping tools 138 on the application 202 while the one or more automated test programs 134 are being executed on the application 202 to extract all of the testable UI elements encoded for the application.

The output of the test coverage tools can include automation test results 214, heatmap data 217 and testable UI elements 218. The automation test results can include test result data generated by the one or more automated UI test programs 134 which can vary depending on the program or programs used. In some embodiments, the automation test results 224 can be included in the test coverage report 224. In other embodiments, the automation test results 224 may be discarded. The heatmap data 216 can include information identifying the executed UI elements, the amount of execution (e.g., number of clicks), the frequency of execution and the order of execution. The heatmap data 216 can also include graphical heatmap elements that provide a visual representation of the executed UI elements with respect to amount of execution (e.g., number of times each UI element was executed successfully by one or more test cases). The testable UI elements 218 can include information identifying all testable UI elements encoded for the application 202 as extracted by the extraction component 110 using the one or more web scraping tools 138.

At 220, the assessment component 114 can perform a coverage assessment based on the heatmap data and the testable UI elements. In this regard, as described above, the assessment component 114 can determine the coverage percentage (e.g., percentage of testable UI elements executed by the one or more automated UI test programs 134) and determine information regarding the non-executed UI elements (e.g., identifiers of the non-executed UI elements, Xpath information for the non-executed UI elements, CSS information for the non-executed UI elements, etc.). At 222, the reporting component can generate a test coverage report 224 comprising the heatmap data 216, the testable UI elements and the results of the assessment at 220. The test coverage report 224 may be stored, exported and/or rendered (e.g., via rendering component 118) to a user via a suitable display device.

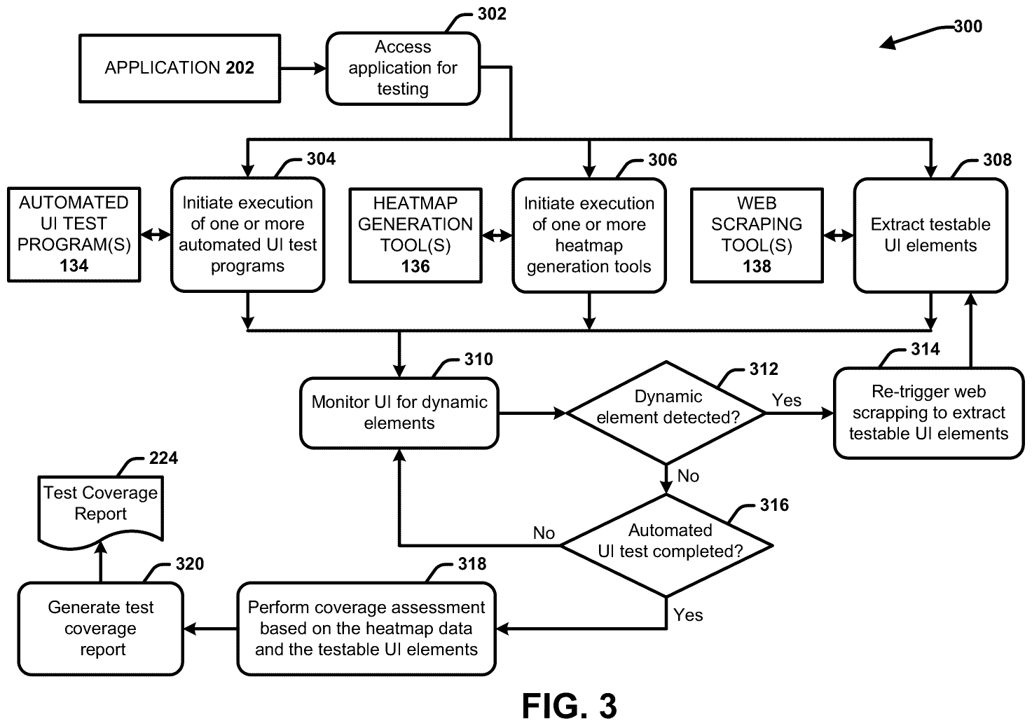

FIG. 3 presents a flow diagram of another example process 300 for performing functional testing of UI-based applications using heat maps in accordance with one or more embodiments of the disclosed subject matter. With reference to FIGS. 1 and 3, process 300 corresponds to another example process that can be performed by system 100 to perform functional testing of executable UI elements of a UI-based application and generate a corresponding comprehensive test coverage report. Repetitive description of like elements employed in respective embodiments is omitted for sake of brevity.

In accordance with process 300, at 302 the computing device 101 can access an application 202 for testing (e.g., using integration component 104). At 304, the computing device 101 can initiate execution (e.g., by processing unit 124 and/or by one or more external systems/devices 130) of one or more automated UI test programs 134 on the application 202 (e.g., using testing component 106 and/or integration component 104). At 306, the computing device 101 can initiate execution (e.g., by processing unit 124 and/or by one or more external systems/devices 130) of one or more heatmap generation tools on the application 202 (e.g., using heatmap component 108 and/or integration component 104). At 308, the computing device 101 can initiate execution (e.g., by processing unit 124 and/or by one or more external systems/devices 130) of one or more web scraping tools 138 on the application 202 (e.g., using extraction component 110). In various embodiments, the computing device 101 can initiate execution of the one or more automated UI test programs 134, the one or more heatmap generation tools 136 and the one or more web scraping tools 138 simultaneously.

At 310, the computing device can monitor (e.g., using monitoring component 112) the UI of the application 202 for dynamic elements (e.g., using a mutation observer tool or the like) while the automated UI test programs 134 are running. In various embodiments, the computing device 101 can initiate the monitoring at the same time of initiation of execution of the one or more automated UI test programs 134. At 312, if the monitoring component detects a dynamic element, then at 314, the monitoring component can re-trigger web scraping to extract the testable UI elements. In this regard, in some embodiments, the extraction component 110 can be configured to perform web-scraping on the application 202 once initially and again iteratively each time a new UI element is rendered as a result of an action performed by the automated UI test program. At 312, if a dynamic UI element is not detected, process 300 can proceed to 316 wherein the testing component 106 determines whether the automated UI testing is completed. If the one or more automated UI testing programs are still being executed/run at 316, then process 300 returns to 310. In this regard, it should be appreciated that once initiated, the one or more automated UI test programs 304 and the heatmap generation tools 136 will continue to run until execution of the one or more automated UI test programs have completed.

At 316, once the testing component 106 determines that the automated UI test programs have completed execution, at 318, the assessment component 114 can perform a coverage assessment based on the heatmap data and the testable UI elements using the results or output of the heatmap generation tools 136 (e.g., heatmap data 216) and the results or output of the web scraping tools 138 (e.g., testable UI elements 218). At 320, the reporting component can generate a test coverage report 224 comprising the heatmap data 216, the testable UI elements and the results of the assessment at 318. The test coverage report 224 may be stored, exported and/or rendered to a user via a suitable display device.

FIG. 4 presents an example reporting GUI 400 of a test coverage reporting tool (e.g., provided by the reporting component 116) for assessing the functionality of UI-based applications using heat maps in accordance with one or more embodiments of the disclosed subject matter. With reference to FIG. 4 in view of FIGS. 1-3, in various embodiments, the reporting component 116 can generate a reporting GUI such as example reporting GUI 400 in association with reporting the test coverage report 224 and the rendering component 118 can render the GUI to a user via display device to facilitate revieing the test coverage report information. As illustrated in FIG. 4, in association with rending the test coverage report information, in some embodiments, the rendering component 118 can render the GUI 402 of the application that was tested. In this example, the application tested includes a website for a café. The GUI 402 of the website includes a home page which is currently displayed. In various implementations, the GUI of application tested may include a plurality of different pages which may be independently selected to review the functional UI test results for each page.

In association with rendering the GUI 402 of the tested application, the reporting component 116 can integrate the heatmap data for the executed UI elements on or withing the GUI 402 to provide a visual representation of the results of the automated UI test programs 134. In this example, the heatmap data includes visual heatmap indicators labeled 1-5 aligned with corresponding UI elements on the page that were executed by the one or more automated UI test programs 134. In this example, the UI elements that were executed include the “home” button, the “about” button, the “menu” button, the “contact” button and the “what we offer” button. The numbers 1-5 respectively indicate the order in which the respective buttons were executed. In this example, the size of the heatmap indicators associated with the executed elements indicates the number of clicks that occurred on the respective UI elements by the automated test script(s). In this regard, the heatmap indicator associated with the “about” button is larger relative to the heatmap indicators for the other executed elements, indicating the about button was activated (e.g., clicked, selected, etc.) more times than the other executed UI elements. In this example, one UI element of the home page, the “events” button, was not executed by the one or more automated UI test programs. As illustrated in FIG. 4, in some embodiments, the reporting component 116 can also generate and associate a visual symbol with the non-executed UI elements of the application as rendered via the reporting GUI 400 that indicates the non-executed UI elements (e.g., which in this example includes a waning symbol).

The reporting GUI 400 can also include a test coverage report section 404 that includes information identifying the test coverage percentage determined by the assessment component 114, which in this example is 71%. As illustrated in this example, in some embodiments, in association with calculating the test coverage percentage, the assessment component 114 can determine different density amounts of the coverage percentage associated with different UI test cases performed by the one or more automated UI test programs 134 and generate a visual graphical representation of this information. In this example, the different UI test cases included four different test cases respectively labeled with the high, medium, low and very low density coverage indicators. In this regard, the heatmap results can be grouped based on each test case to add more value from business perspective. Accordingly, domain experts can easily review the grouped test results to identify if any domain-specific scenarios are missing, saving a significant amount of time compared to traditional review automation test process that do not generate visual representation of the results. In some embodiments, the reporting component 116 can also use suitable APIs (e.g., Jira Rest APIs) to link the automated test cases to the feature/epic and the test results can be populated from any continuous integration and continuous delivery (CI/CD) tool, thereby providing more accurate test coverage reports. The test coverage report section 404 can also include buttons that may be selected to review additional information regarding the testable elements extracted by the extraction component 110 (e.g., testable elements summary button 406), the executed elements (e.g., executed elements summary button 408) and the non-executed elements (e.g., non-executed elements summary button.

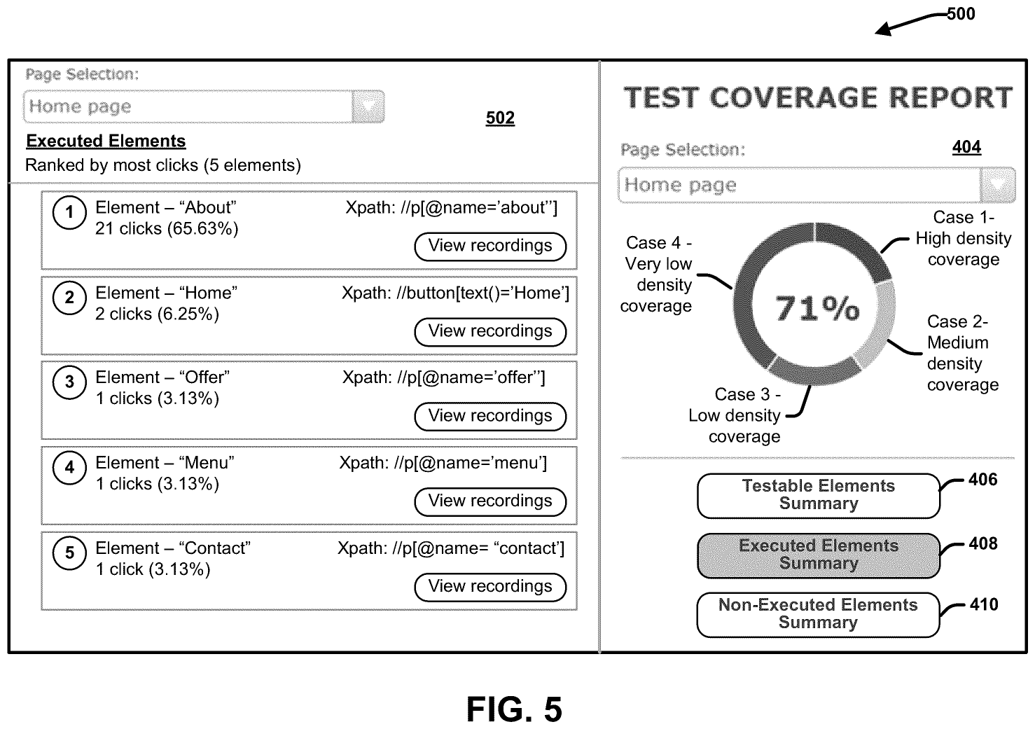

FIG. 5 presents another example GUI 500 of the test coverage reporting tool that can be rendered in response to selection of the executed elements summary button 408 displayed in GUI 400. As shown in example GUI 500, in some embodiments, the test coverage report information can include a list 502 of the executed UI elements with information identifying the executed UI elements, their respective Xpaths and the number of clicks received for each UI element.

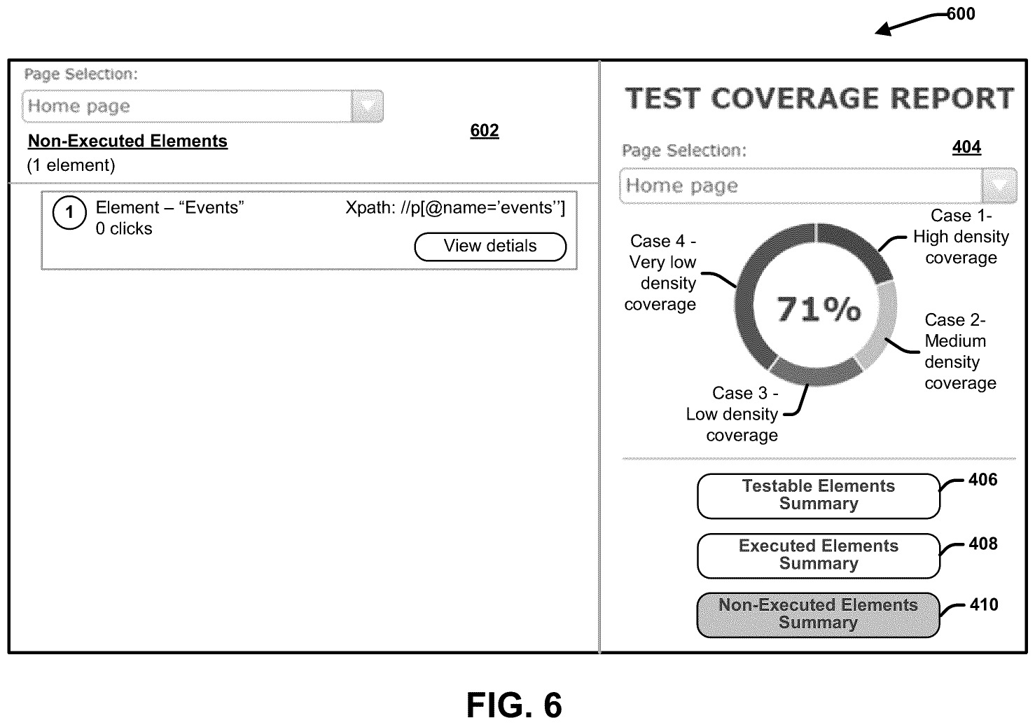

FIG. 6 presents another example GUI 600 of the test coverage reporting tool that can be rendered in response to selection of the non-executed elements summary button 410. As shown in example GUI 600, in some embodiments, the test coverage report information can include a list 602 of the non-executed UI elements with information identifying the non-executed UI elements, their respective Xpaths.

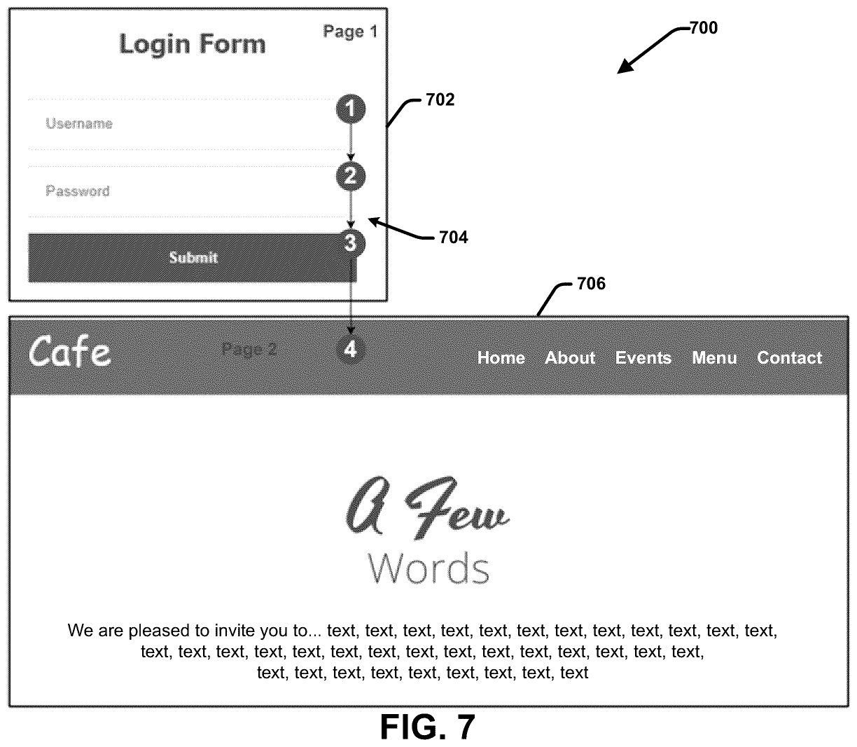

FIG. 7 presents an example reporting GUI 700 of a test coverage reporting tool (e.g., provided by the reporting component 116) for assessing the functionality of UI-based applications using heat maps in accordance with one or more embodiments of the disclosed subject matter. With reference to FIG. 7 in view of FIGS. 1-6, in some embodiments, the reporting component 116 can generate a reporting GUI such as example reporting GUI 700 in association with reporting the test coverage report 224 and the rendering component 118 can render the GUI to a user via display device to facilitate reviewing the test coverage report information with another type of visual representation. As illustrated in FIG. 7, in some embodiments, the reporting GUI can include an ordered page by page view of the GUI of the tested application, which in this example includes a login form page 702 and a home page 706. In some implementations of these embodiments, a different UI test case can be applied to each page of the application and the reporting component can render the results relative to the corresponding page, providing another visual representation of the heatmap results groups based on each test case corresponding to each page. In addition, the reporting component 114 can generate and integrate visual indicators with each executed UI element indicating the order in which the respective elements were executed (e.g., illustrated in FIG. 7 with numbers 1-4).

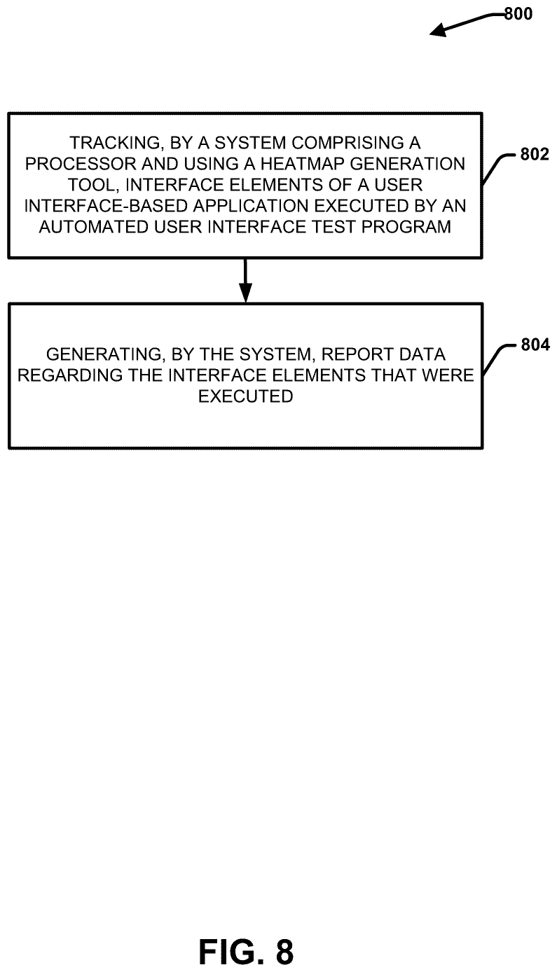

FIG. 8 illustrates a block diagram of an example, non-limiting computer implemented method 800 performing functional testing of a UI-based application using heat maps in accordance with one or more embodiments of the disclosed subject matter. Method 800 comprises, at 802, tracking, by a system comprising a processor (e.g., system 100) and using a heatmap generation tool (e.g., one or more of the heatmap generation tools 136) interface elements of a UI-based application executed by an automated UI test program (e.g., one or more of the automated UI test programs 134). At 804, method 800 comprises generating, by the system, report data regarding the interface elements that were executed (e.g., via reporting component 116)

In some embodiments, method 800 can further comprise generating, by the system, heatmap data for the interface elements that were executed using the heatmap generation tool, wherein the report data comprises the heatmap data. In some embodiments, the heatmap data comprises graphical heatmap elements for the interface elements that were executed, and wherein the method further comprises embedding, by the system (e.g., using reporting component 116 and/or heatmap component 108), the graphical heatmap elements within the user interface-based application at positions relative to the interface elements. In some embodiments, method 800 can further comprise determining, by the system (e.g., via assessment component 114), test coverage information regarding non-executed interface elements of the UI-based application that were not executed by the automated UI test program, and wherein the generating the report data comprises including the test coverage information in the report data. In some implementations of these embodiments, the test coverage information indicates an amount of the non-executed interface elements, and wherein the method further comprises determining, by the system, a total amount of testable interface elements encoded for the user interface-based application; and determining, by the system, the amount of non-executed interface elements as a function of the total amount of testable interface elements relative to the interface elements that were executed. In some implementations, determining the total amount comprises determining the total amount using a web-scraping tool (e.g., of the one or more web scraping tools 138).

One or more embodiments of the disclosed subject matter can be a system, a method, and/or a computer program product at any possible technical detail level of integration. The computer program product can include a computer readable storage medium (or media) having computer readable program instructions thereon for causing a processor to carry out one or more parts of the present embodiments.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. In this regard, a computer readable storage medium as user herein can include or correspond to a non-transitory machine readable storage medium.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiment(s) can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, procedural programming languages, such as the “C” programming language or similar programming languages, and machine-learning programming languages such as like CUDA, Python, Tensorflow, PyTorch, and the like. The computer readable program instructions can execute entirely on the user's computer, partly on the user's computer, as a stand-alone software package, partly on the user's computer and partly on a remote computer or entirely on the remote computer or server using suitable processing hardware. In the latter scenario, the remote computer can be connected to the user's computer through any type of network, including a local area network (LAN) or a wide area network (WAN), or the connection can be made to an external computer (for example, through the Internet using an Internet Service Provider). In various embodiments involving machine-learning programming instructions, the processing hardware can include one or more graphics processing units (GPUs), central processing units (CPUs), and the like. For example, one or more inferencing models (e.g., multi-task inferencing models, sub-models, or components thereof) may be written in a suitable machine-learning programming language and executed via one or more GPUs, CPUs or combinations thereof. In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform part(s) of the present embodiment(s).

One or more embodiments of the present application are described herein with reference to flowchart illustrations and/or block diagrams of methods, apparatus (systems), and computer program products according to embodiments of the present application. It can be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects or processes of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present application. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession may, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In connection with FIG. 8, the systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which can be explicitly illustrated herein.

With reference to FIG. 9, an example environment 900 for implementing various embodiments of the subject application includes a computer 902. The computer 902 includes a processing unit 904, a system memory 906, a codec 935, and a system bus 908. The system bus 908 couples system components including, but not limited to, the system memory 906 to the processing unit 904. The processing unit 904 can be any of various available processors. Dual microprocessors and other multiprocessor architectures also can be employed as the processing unit 904.

The system bus 908 can be any of several types of bus structure(s) including the memory bus or memory controller, a peripheral bus or external bus, or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 906 includes volatile memory 910 and non-volatile memory 912, which can employ one or more of the disclosed memory architectures, in various embodiments. The basic input/output system (BIOS), containing the basic routines to transfer information between elements within the computer 902, such as during start-up, is stored in non-volatile memory 912. In addition, according to present innovations, codec 935 can include at least one of an encoder or decoder, wherein the at least one of an encoder or decoder can consist of hardware, software, or a combination of hardware and software. Although codec 935 is depicted as a separate component, codec 935 can be contained within non-volatile memory 912. By way of illustration, and not limitation, non-volatile memory 912 can include read only memory (ROM), programmable ROM (PROM), electrically programmable ROM (EPROM), electrically erasable programmable ROM (EEPROM), Flash memory, 3D Flash memory, or resistive memory such as resistive random access memory (RRAM). Non-volatile memory 912 can employ one or more of the disclosed memory devices, in at least some embodiments. Moreover, non-volatile memory 912 can be computer memory (e.g., physically integrated with computer 902 or a mainboard thereof), or removable memory. Examples of suitable removable memory with which disclosed embodiments can be implemented can include a secure digital (SD) card, a compact Flash (CF) card, a universal serial bus (USB) memory stick, or the like. Volatile memory 910 includes random access memory (RAM), which acts as external cache memory, and can also employ one or more disclosed memory devices in various embodiments. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM) and so forth.

Computer 902 can also include removable/non-removable, volatile/non-volatile computer storage medium. FIG. 9 illustrates, for example, disk storage 914. Disk storage 914 includes, but is not limited to, devices like a magnetic disk drive, solid state disk (SSD), flash memory card, or memory stick. In addition, disk storage 914 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 914 to the system bus 908, a removable or non-removable interface is typically used, such as interface 916. It is appreciated that disk storage 914 can store information related to an entity. Such information might be stored at or provided to a server or to an application running on an entity device. In one embodiment, the entity can be notified (e.g., by way of output device(s) 936) of the types of information that are stored to disk storage 914 or transmitted to the server or application. The entity can be provided the opportunity to opt-in or opt-out of having such information collected or shared with the server or application (e.g., by way of input from input device(s) 928).

It is to be appreciated that FIG. 9 describes software that acts as an intermediary between entities and the basic computer resources described in the suitable operating environment 900. Such software includes an operating system 918. Operating system 918, which can be stored on disk storage 914, acts to control and allocate resources of the computer system 902. Applications 920 take advantage of the management of resources by operating system 918 through program modules 924, and program data 926, such as the boot/shutdown transaction table and the like, stored either in system memory 906 or on disk storage 914. It is to be appreciated that the claimed subject matter can be implemented with various operating systems or combinations of operating systems.

An entity enters commands or information into the computer 902 through input device(s) 928. Input devices 928 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 904 through the system bus 908 via interface port(s) 930. Interface port(s) 930 include, for example, a serial port, a parallel port, a game port, and a universal serial bus (USB). Output device(s) 936 can use some of the same type of ports as input device(s) 928. Thus, for example, a USB port can be used to provide input to computer 902 and to output information from computer 902 to an output device 936. Output adapter 934 is provided to illustrate that there are some output devices 936 like monitors, speakers, and printers, among other output devices 936, which require special adapters. The output adapters 934 include, by way of illustration and not limitation, video and sound cards that provide a means of connection between the output device 936 and the system bus 908. It should be noted that other devices or systems of devices provide both input and output capabilities such as remote computer(s) 938.

Computer 902 can operate in a networked environment using logical connections to one or more remote computers, such as remote computer(s) 938. The remote computer(s) 938 can be a personal computer, a server, a router, a network PC, a workstation, a microprocessor based appliance, a peer device, a smart phone, a tablet, or other network node, and typically includes many of the elements described relative to computer 902. For purposes of brevity, only a memory storage device 940 is illustrated with remote computer(s) 938. Remote computer(s) 938 is logically connected to computer 902 through a network interface 942 and then connected via communication connection(s) 944. Network interface 942 encompasses wire or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 944 refers to the hardware/software employed to connect the network interface 942 to the bus 908. While communication connection 944 is shown for illustrative clarity inside computer 902, it can also be external to computer 902. The hardware/software necessary for connection to the network interface 942 includes, for exemplary purposes only, internal and external technologies such as, modems including regular telephone grade modems, cable modems and DSL modems, ISDN adapters, and wired and wireless Ethernet cards, hubs, and routers.

The illustrated embodiments of the disclosure may also be practiced in distributed computing environments where certain tasks are performed by remote processing devices that are linked through a communications network. In a distributed computing environment, program modules can be located in both local and remote memory storage devices.

Referring to FIG. 10, there is illustrated a schematic block diagram of a computing environment 1000 in accordance with this disclosure in which the subject system (e.g., system 100 and the like), methods and computer readable media can be deployed. The computing environment 1000 includes one or more client(s) 1002 (e.g., laptops, smart phones, PDAs, media players, computers, portable electronic devices, tablets, and the like). The client(s) 1002 can be hardware and/or software (e.g., threads, processes, computing devices). The computing environment 1000 also includes one or more server(s) 1004. The server(s) 1004 can also be hardware or hardware in combination with software (e.g., threads, processes, computing devices). The servers 1004 can house threads to perform transformations by employing one or more embodiments of this disclosure, for example. In various embodiments, one or more components, devices, systems, or subsystems of system 100 can be deployed as hardware and/or software at a client 1002 and/or as hardware and/or software deployed at a server 1004. One possible communication between a client 1002 and a server 1004 can be in the form of a data packet transmitted between two or more computer processes wherein the data packet may include healthcare related data, training data, ML models, input data for the ML models, encrypted output data generated by the ML models, and the like. The data packet can include a metadata, e.g., associated contextual information, for example. The computing environment 1000 includes a communication framework 1006 (e.g., a global communication network such as the Internet, or mobile network(s)) that can be employed to facilitate communications between the client(s) 1002 and the server(s) 1004.

Communications can be facilitated via a wired (including optical fiber) and/or wireless technology. The client(s) 1002 include or are operatively connected to one or more client data store(s) 1008 that can be employed to store information local to the client(s) 1002. Similarly, the server(s) 1004 are operatively include or are operatively connected to one or more server data store(s) 1012 that can be employed to store information local to the servers 1004.

In one embodiment, a client 1002 can transfer an encoded file, in accordance with the disclosed subject matter, to server 1004. Server 1004 can store the file, decode the file, or transmit the file to another client 1002. It is to be appreciated that a client 1002 can also transfer an uncompressed file to a server 1004 that can compress the file in accordance with the disclosed subject matter. Likewise, server 1004 can encode video information and transmit the information via communication framework 1006 to one or more clients 1002.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can also be practiced in distributed computing environments where tasks are performed by remote processing devices that are linked through a communications network. However, some, if not all, embodiments of this disclosure can be practiced on stand-alone computers. In a distributed computing environment, program modules can be located in both local and remote memory storage devices.

As used in this application, the terms “component,” “system,” “subsystem” “platform,” “layer,” “gateway,” “interface,” “service,” “application,” “device,” and the like, can refer to and/or can include one or more computer-related entities or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an example embodiment, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration and are intended to be non-limiting. For the avoidance of doubt, the subject matter disclosed herein is not limited by such examples. In addition, any aspect, embodiment, element, act, design, etc. described herein as an “example” and/or “exemplary” is not necessarily to be construed as preferred or advantageous over other aspects, embodiments, elements, acts, designs, etc., nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of entity equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above includes mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Many modifications and variations can be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer-executable components; and
a processor that executes the computer-executable components stored in the memory, wherein the computer-executable components comprise:
a heatmap component that employs a heatmap generation tool to track interface elements of a user interface-based application executed by an automated user interface test program; and
a reporting component that generates report data regarding the interface elements that were executed.

2. The system of claim 1, wherein the heatmap component employs the heatmap generation tool to generate heatmap data for the interface elements that were executed, and wherein the report data comprises the heatmap data.

3. The system of claim 2, wherein the computer-executable components further comprise:
a rendering component that renders the report data via a display device.

4. The system of claim 3, wherein the heatmap data comprises graphical heatmap elements for the interface elements that were executed, and wherein the rendering component displays the graphical heatmap elements at positions relative to the interface elements as rendered via the display device.

5. The system of claim 1, wherein the computer-executable components further comprise:
an assessment component that determines test coverage information regarding non-executed interface elements of the user interface-based application that were not executed by the automated user interface test program, and wherein the reporting component includes the test coverage information in the report data.

6. The system of claim 5, wherein the test coverage information indicates an amount of the non-executed interface elements, and wherein the computer-executable components further comprise:
an extraction component that determines a total amount of testable interface elements encoded for the user interface-based application, wherein the assessment component determines the amount of non-executed interface elements as a function of the total amount of testable interface elements relative to the interface elements that were executed.

7. The system of claim 6, wherein the extraction component determines the total amount of testable interface elements using a web-scraping tool.

8. The system of claim 1, wherein the computer-executable components further comprise:
a testing component that executes the automated user interface test program on the user interface-based application, and wherein the heatmap component executes the heatmap generation tool in association with execution of the automated user interface test program by the testing component.

9. The system of claim 8, wherein the computer-executable components further comprise:
an extraction component that extracts information regarding testable interface elements encoded for the user interface-based application in association with the execution of the automated user interrace test program by the testing component.

10. The system of claim 9, wherein the computer-executable components further comprise:
a monitoring component that monitors the execution of the automated user interface program by the testing component detects loading of dynamic interface elements, and wherein the extraction component extracts the information regarding the testable interface elements in response to detection of the loading of the dynamic interface elements by the monitoring component.

11. A method, comprising:
tracking, by a system comprising a processor and using a heatmap generation tool, interface elements of a user interface-based application executed by an automated user interface test program; and
generating, by the system, report data regarding the interface elements that were executed.

12. The method of claim 11, further comprising:
generating, by the system, generate heatmap data for the interface elements that were executed using the heatmap generation tool, wherein the report data comprises the heatmap data.

13. The method of claim 12, wherein the heatmap data comprises graphical heatmap elements for the interface elements that were executed, and wherein the method further comprises:
embedding, by the system, the graphical heatmap elements within the user interface-based application at positions relative to the interface elements.

14. The method of claim 11, further comprising:
determining, by the system, test coverage information regarding non-executed interface elements of the user interface-based application that were not executed by the automated user interface test program, and wherein the generating the report data comprises including the test coverage information in the report data.

15. The method of claim 14, wherein the test coverage information indicates an amount of the non-executed interface elements, and wherein the method further comprises:
determining, by the system, a total amount of testable interface elements encoded for the user interface-based application; and
determining, by the system, the amount of non-executed interface elements as a function of the total amount of testable interface elements relative to the interface elements that were executed.

16. The method of claim 15, wherein determining the total amount comprises determining the total amount using a web-scraping tool.

17. The method of claim 11, further comprising:
executing, by the system, the automated user interface test program on the user interface-based application; and
executing, by the system, the heatmap generation tool in association with the executing of the automated user interface test program.

18. The method of claim 17, further comprising:
extracting, by the system, information regarding testable interface elements encoded for the user interface-based application in association with the executing of the automated user interrace test program.

19. A non-transitory machine-readable storage medium, comprising executable instructions that, when executed by a processor, facilitate performance of operations, comprising:
employing a heatmap generation tool to track interface elements of a user interface-based application executed by an automated user interface test program; and
generating report data regarding the interface elements that were executed.

20. The non-transitory machine-readable storage medium of claim 19, wherein the operations further comprise:
generating generate heatmap data for the interface elements that were executed using the heatmap generation tool; and
embedding the heatmap data within the user interface-based application at positions relative to the interface elements.
